(19) United States
(12) Patent Application Publication
(10) Pub. No.: US 2014/0040035 A1
(43) Pub. Date: Feb. 6, 2014

(54) METHOD AND SYSTEM OF USING SMARTPHONE LOCKSCREENS AS PERSONAL ADVERTISING BILLBOARDS

(71) Applicant: Elijah Cusack, Las Vegas, NV (US)

(72) Inventor: Elijah Cusack, Las Vegas, NV (US)

(21) Appl. No.: 13/566,523

(22) Filed: Aug. 3, 2012

(51) Int. Cl. G06Q 30/02

(52) U.S. Cl. 705/14.61

(57) ABSTRACT

Method, system, and software product for displaying advertising media on the lockscreens of handheld computerized devices, such as smartphones. The invention comprises an advertising software app, and corresponding advertising internet server software. Merchants and other advertisers can transmit ads, along with corresponding ad display schedule information, and target ad recipient demographic information, to the server. The smartphone app software can collect user data, forward it to the server, and obtain from the server corresponding ad images that are displayed on the smartphone's lockscreen. The system may optionally keep track of usage and compensate smartphone users accordingly. Smartphone users, on seeing an ad of interest, can either use the ad image directly, transmit the ad image to a recipient, or jump to a web address corresponding to an ad associated URL. The method essentially allows a smartphone user to rent out his smartphone lockscreen as if it was a personal billboard.

### BACKGROUND OF THE INVENTION

1. Field of the Invention

This invention is in the field of electronic, internet-based, advertising technology for smartphones and other handheld computerized devices.

2. Description of the Related Art

The use of various computerized devices for delivering advertising, in particular handheld computerized devices with wireless connections to the internet via WiFi and cellular telephone links, has exploded in recent years.

Such handheld computerized devices, exemplified by laptop computers, tablet computers, and smartphones, often run iOS, Android, Windows, or other operating systems on one or more microprocessors. Numerous types of software, such as web browsers or applications software, are available that can configure these devices to receive advertisements (ads) from various sources, usually over the internet.

As an example, it is now common to install a freeware app on a smartphone (such as an Apple iPhone, Android Smartphone, Windows Smartphone, and the like) that will display ads at various times during the app operation, such as an app startup splash screen, in a section of the app screen while other app software is also being displayed, or periodically as various advertising “nag” screens. By paying for the freeware, these ads may be permanently disabled.

Additionally, certain tablet computerized devices, exemplified by the Amazon Kindle Touch, are also available. The Amazon Kindle Touch, for example, is often sold at a reduced price through Amazon's “special offers” program. In this special offers program, a Kindle Touch that might normally sell for $139 is instead sold at a reduced price of $99. A Kindle Touch with special offers will show an adverting screen when the device is switched off and is otherwise in an inoperative state. This “advertising screen while off” mode is possible because the device's electronic ink display continues to show an image even when the device is otherwise powered down.

When touch sensitive smartphones, such as the Apple iPhone, were originally developed, the designers noted that such devices had some specific user interface problems. The designers determined that the smartphone devices had to remain continually powered on in order to receive phone calls. However the designers also found that it was impractical to design the systems so that users had to first activate the smartphone's touch screen sensor by pressing a non-screen located power button; and then further control the smartphone by pressing virtual buttons on the device's touch screen. The designers also found that it was impractical to keep the smartphone's touch screen on and continually responsive to all touch input, because such devices are often stored in the user's pocket or purse. In the pocket or purse environment, such touch screens are constantly exposed to accidental contact with other objects.

In order to overcome this problem, the designers employed various types of “lockscreen” concepts. In lockscreen mode, a device's touch sensitive display remains touch sensitive, even if the device is nominally conserving energy by not powering on the device's display screen or display screen backlight (if any). Upon detecting a touch on the touch screen, the device may in turn power on the display screen and show an image (a lockscreen image), but in order to fully activate the device, the user will be required to initiate a specific touch action, such as moving a representation of a slider by touch, that would otherwise be very unlikely to occur by random contact with objects in the user's pocket or purse. This method of unlocking a device by performing gestures on an unlock image is described in U.S. Pat. No. 7,657,849 by Chaudhri et. al., the contents of which are incorporated herein by reference.

Alternative methods of using gestures on unlock images (lockscreen images) have also been proposed. These include U.S. Pat. No. 8,136,053 by Miller and Trivi, incorporated herein by reference, which use other types of specific user gestures on lockscreen images to unlock smartphones and other types of mobile computerized devices with touch sensitive display screens.

### BRIEF SUMMARY OF THE INVENTION

The invention is based, in part, on the insight that the lockscreen image presented by smartphones and other types of touch sensitive mobile computerized devices represents a presently untapped resource for showing ads. This is a remarkable omission, because lockscreens represent an excellent vehicle for displaying ads. This is because a typical smartphone user will often look at his or her device's lockscreen many times a day; generally whenever the user receives a telephone call, initiates a telephone call, or otherwise tries to use the device for almost any activity.

The invention is also based, in part, on the insight that in order to persuade users to in effect rent out their device's lockscreen images as a personal billboard for advertising purposes, some sort of commercial inducement will be required. Although standard advertising inducements such as electronic coupons with various price reductions, and the like, may be used, this may not always be sufficient. Thus in some embodiments of the invention, users are further incentivized to allow advertisements to be displayed on their device's lockscreens through a money payment system. Here for example, users may receive nominal money payments for simply keeping their device's lockscreen advertising software active, and for viewing the lockscreen ads (such as by unlocking the device) according to an established reimbursement schedule. Although this money for viewing lockscreen ads tradeoff will increase advertising costs to some extent, advertisers may justify this added expense because in addition to direct ad viewing by demographically targeted users, the user of the lockscreen ad equipped device may also access the product for sale directly from the lockscreen with an active button as well as show or relay various lockscreen ads to friends and associates by using screen capture. This helps generate some additional and valuable word-of-mouth advertising.

The invention is also based, in part, on the insight that in order to manage such a lockscreen ad system (e.g. personal billboard system) effectively, the system would require at least a first computerized device software component (e.g. a smartphone app), an a second internet server software based component. The first computerized device software component would intercept ad media (e.g. ad images) from the internet, and assign the ad media to the device's lockscreen image according to a schedule. The second internet server based software component would direct one or more internet servers to dispense the ads to various participating computerized devices. This second internet server based software component would ideally have both a merchant interface by which to receive ads and ad display criteria (e.g. various target ad recipient demographic criteria) from various merchants. The second internet server based software component would also have database software capable of receiving user demographic data from the various computerized device users, appropriately matching the user data with the merchant ad display criteria, and then further dispense those ads (ad media, ad image) to the appropriate user devices.

Thus in some embodiments, the invention may be a method of displaying advertising media on the lockscreens of a plurality of wireless network connected handheld computerized devices. Here, the users (or alternatively the manufacturers) of the various computerized devices, such as smartphones, will typically install an advertising display software app (or alternatively embed this software as part of the device's operating system) on at least one such computerized devices, and typically a large number of different computerized devices. This advertising display software app, which will be installed on a per-device basis, will typically be configured to receive user data pertaining to the user of said device. This data can often be demographic data such as the user's age, sex, location, income bracket (geographic, by zip code, or by other method), and personal interests.

The advertising display software app will typically be configured to wirelessly transmit at least some of this user data to (at least one) network server, as well as wirelessly receive advertising data from this network server. The software app will further display this advertising media (e.g. often a plurality of different ad images) on the device's lockscreen according to an advertising display schedule.

In use, merchants, or other individuals or organizations interested in advertising, will usually upload their particular advertising media to the network server, along with a description of a target recipient population for the ads. Thus for example, the merchant may state that a given ad for pizza should be targeted to college age students in one or more zip codes near one or more colleges.

The server will then use the user data previously obtained from the software apps running on the various computerized devices, and the merchant's description of a target recipient population, to determine which of the various devices should receive which advertising media. The server will then upload the advertising media the appropriate devices. These devices in turn will then use the software app to then display the appropriate advertising media on the device's lockscreen, often according to a particular merchant, server, or user selected advertising display schedule.

### BRIEF DESCRIPTION OF THE DRAWINGS

FIG. 1 shows an example of a smartphone lockscreen showing an 1800's era advertisement for “Parker's Ginger Tonic”.

FIG. 2 shows an overview of how the invention's server software interacts with both data from merchants/advertisers, and data from software running on various client computerized devices, to distribute ads to be shown on the lockscreens of these various computerized devices.

FIG. 3 shows how the database component of the invention's server software may receive various types of user data from various computerized devices, match this data up with advertising data describing the intended target recipient population (obtained from various merchants), and when the user data matches up with the target data, transmit the appropriate advertising media (e.g. lockscreen images) to the appropriate handheld computerized devices (e.g. smartphones).

FIG. 4 shows a software flow chart showing some of the key steps on both the server software and the client software that may be used to implement the present invention.

FIG. 5 shows how a device user may capture a screenshot of a lockscreen ad of interest, and forward this ad (here the ad is also being used as a coupon) to an appropriate recipient.

### DETAILED DESCRIPTION OF THE INVENTION

As previously discussed, in some embodiments, the invention may be a method, system, or software product that enables advertising media, typically graphic images, to be displayed on the lockscreens of various computerized devices. These computerized devices will typically be handheld computerized devices with touch sensitive screens, which are configured to go from a locked configuration that is generally non-responsive to touch input, to an unlocked configuration that is generally responsive to touch input, upon receiving an unlocking touch gesture, such as a finger swipe on a particular location of the screen, or other statistically unlikely touch input generally indicative of a human desire to activate the device.

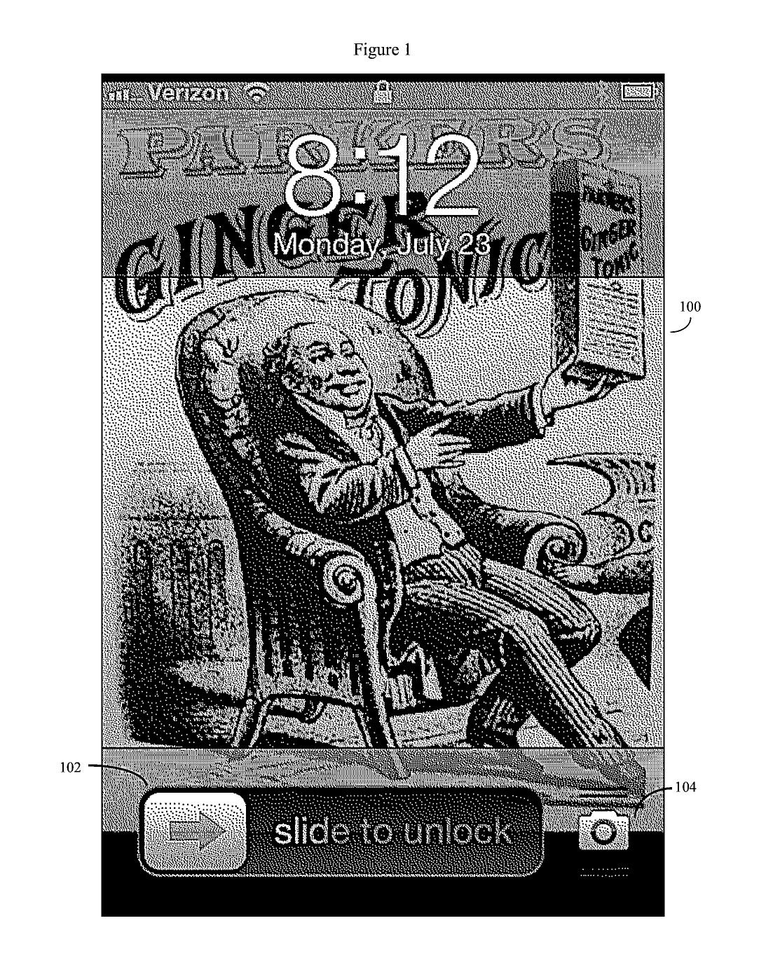

FIG. 1 shows an example of a smartphone lockscreen type advertisement (100), here based on an 1800's era advertisement for “Parker's Ginger Tonic” to avoid copyright issues with present day advertisers. Here this advertisement is shown as an Apple iPhone 4 type lockscreen. In this configuration, by pressing what Apple describes as the iPhone 4's “on/off” button (but which is better described as an “attention button”), the iPhone device changes from a lower power mode where, the device's transmitter and receiver(s) are active, but the display is generally off, to a higher power mode where the display is illuminated, the touch sensor is on, but in which the system otherwise has a restricted sensitivity to touch input.

Upon sensing a finger swipe on the “slide to unlock section” (102), the iPhone device will then unlock and allow access to other icons and other touch sensitive functions. Note that in this Apple iOS 5.1 example, upon detecting a finger swipe on another area of the touch screen (104) distinct from the slide to unlock section, here shown as a camera icon, the iPhone 4 device is also capable of taking photos from the lockscreen mode as well. This is a useful secondary function, and in an alternative embodiment of the invention, an alternative type lockscreen finger swipe motion on a secondary part of the lockscreen may also be used to record the user's interest in the advertisement, as well as to direct the system to, for example, jump to a corresponding advertising website.

Although such computerized devices, such as smartphones, may often be configured to operate in a lower power mode prior to touch activation, such computerized devices will nonetheless remain powered on and capable of receiving wireless signals, such as WiFi or Cellular telephone signals, prior to touch activation. In this respect the computerized devices which are the subject matter of the present invention are more closely related to devices such as the popular Apple iPhone/iPod touch/iPad series of devices, or to various Android series smartphones and tablets. By contrast, devices such as the Amazon Kindle touch, which are typically configured to be in an unpowered “off” stage when not in use, which do not receive wireless input in their inactive state, and which require a button push to activate rather than touch screen input to activate, are generally not covered by the present invention.

According to the method, the users or owners of the various computerized devices (often referred to in the alternative here as a smartphone for brevity) will usually install software, such as an advertising software app, onto their various respective machines. Alternatively this advertising software may be preloaded by the device manufacturer, or even configured as to be part of the handheld computerized device's operating system.

Often, at least as a part of the initial installation process, and optionally on an ongoing basis, this advertising software app will usually be configured to receive user data pertaining to the user of the particular device that the software is installed upon. For example, as part of the installation process, the software app may query the user as to the user's age, sex, location (or request access to the device's GPS location data), user's interests, and other user demographic data. The software app will usually then transmit some or all of this data, usually by wireless communications methods, to the invention's internet server.

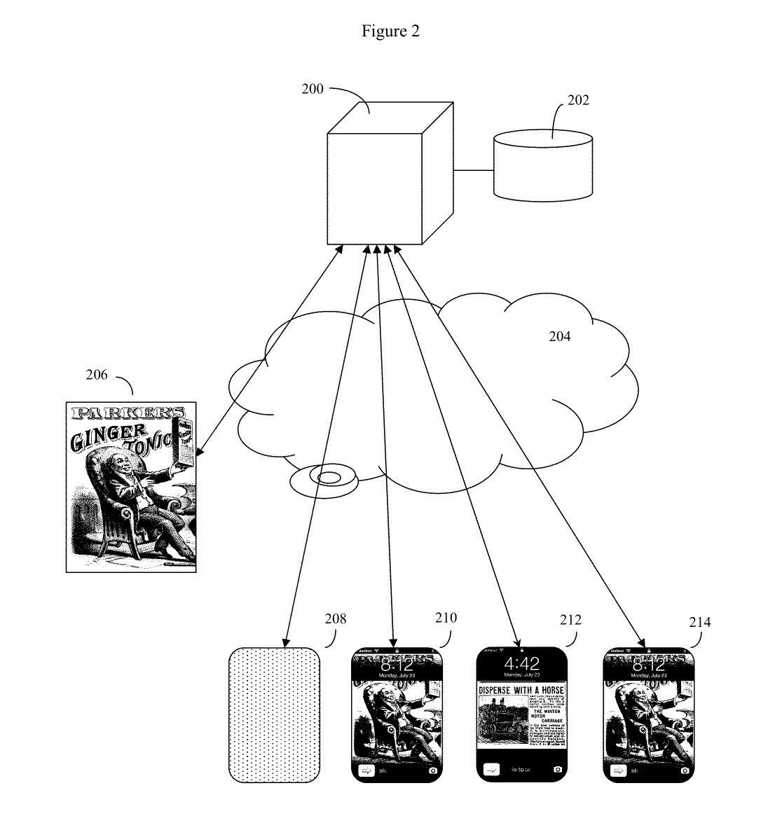

FIG. 2 shows an overview of how the invention's internet server (200) and database (202) interacts, over the internet (204) and various wireless network connections, with merchant/advertiser devices (206) and app software running on various the client computerized devices (208, 210, 212, 214), to distribute ads to be shown on the lockscreens of these various computerized devices.

The software apps running on the various computerized devices (208, 210, 212, 214) will, in turn receive, again usually over a wireless internet network connection (204), advertising data (e.g. lockscreen ad images) from the network server (200), and display this advertising media on the lockscreen (100) of the various handheld computerized devices according to an advertising ad display schedule. This display schedule, may, for example, call for specific downloaded ads to be displayed on the lockscreen at various times, such as when the advertiser believes that the ad will be most effective. Thus for example, an ad for breakfast cereal may be preferentially displayed during the morning hours, while an ad for pizza may be preferentially displayed during the afternoon or evening hours.

In some embodiments, the device software app may be further programmed to periodically report the device's location and/or lockscreen usage pattern to the server. Using this information, the server in turn may, for example, preferentially decide to display “rent a car” lockscreen ads or “hotel” lockscreen ads if the server determines that the device is being used while the user is traveling.

Merchants or other advertisers (206) desiring to use the system can then upload advertising data, and a description of the desired characteristics of the target recipient population for these ads, to the network server (200). The invention's server software running on the network server (200) can then use this user data, along with a description of the target recipient population, to determine which of the various devices (208, 210, 212, 214) should receive which advertising media. The server software can then direct the network server (200) to upload the relevant advertising media (e.g. ad images) to the appropriate devices (208, 210, 212, 214). Once this advertising media had been received by the device (e.g. smartphone), the invention's software app can, as previously described, then display this advertising media on the device's lockscreen according to the advertising display schedule.

To allow merchants and other advertisers to upload this relevant advertising media, usually the network server (200) and database (202), in addition to the standard features such as at least one processor, memory, operating system software (e.g. Linux, Windows, Unix, etc.), web server software (e.g. Apache) support software (e.g. database software, script interpreter software, and the like) will also comprise advertising front end software. This advertising front end software will often be configured so that the merchant, often using the merchant's own internet connected computerized device (206), can use the front end software running on server (200) to upload advertising media and a description of a target recipient population from the merchant computerized device (206). Often a plurality of different merchants and advertisers will use the system. Indeed the system may be configured so as to make it extremely easy for nearly any advertiser of legal products and services to use the system.

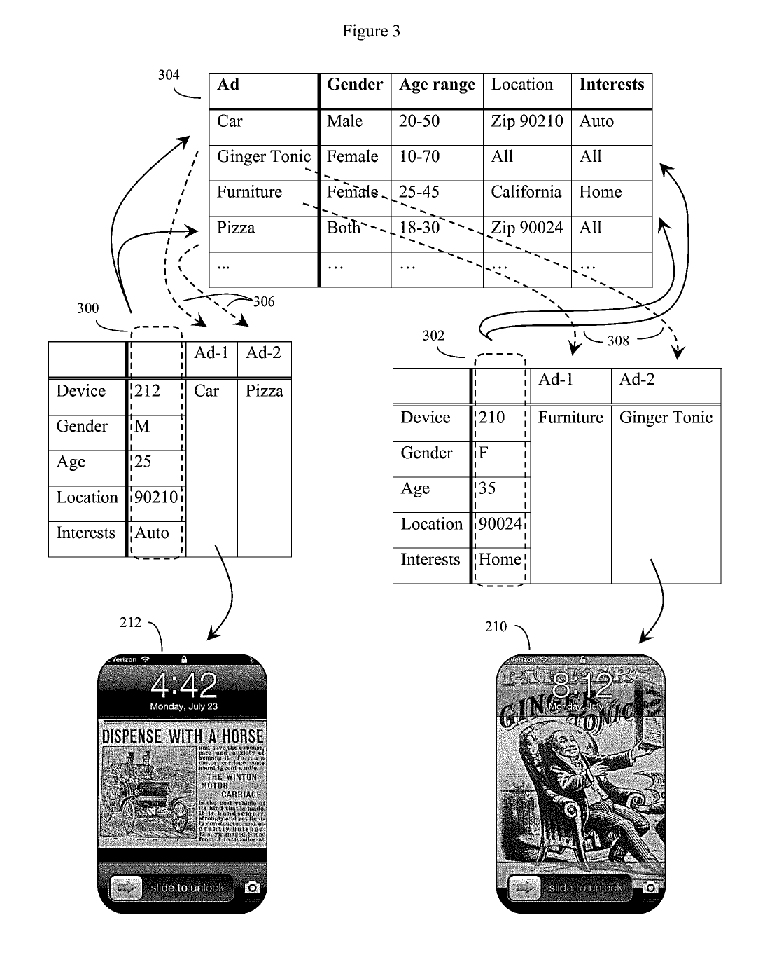

FIG. 3 shows how the invention's server (200) database (202) software may receive various types of user data (300), (302) from various computerized devices (e.g. 210, 212), match this user data up with advertising data (304), such as data from merchant or advertiser (206) (or other merchants and advertisers) that describes the intended target recipient population on the server (202, 204). When the user data (300, 302) matches up with the advertiser's description of the target recipient population (304), the server (200) can then transmit (306, 308) the appropriate advertising media (e.g. lockscreen images) to the appropriate handheld computerized devices (e.g. smartphones, such as 210, 212).

As previously discussed, this matching process will often be done by computer database software (200), (202), running on the network server and database. This database software may be configured to match the merchant's or advertiser's description of a target recipient population (304) with user data (300), (302). As a result of this matching process, the invention can determine which of the various devices (e.g. 208, 210, 212, 214) should receive which advertising media (306), (308).

In some embodiments, the network server software will further comprise ad scheduling software. This ad scheduling software can be used to determine a time schedule by which the various ads will be displayed on the lockscreens of the various devices (e.g. 208, 210, 212, 214), and may optionally transmit various ad display time schedules to the various advertising display software apps running on the various devices (e.g. 208, 210, 212, 214). This schedule data can be used to control the times and durations in which the various advertising lockscreen ads are displayed.

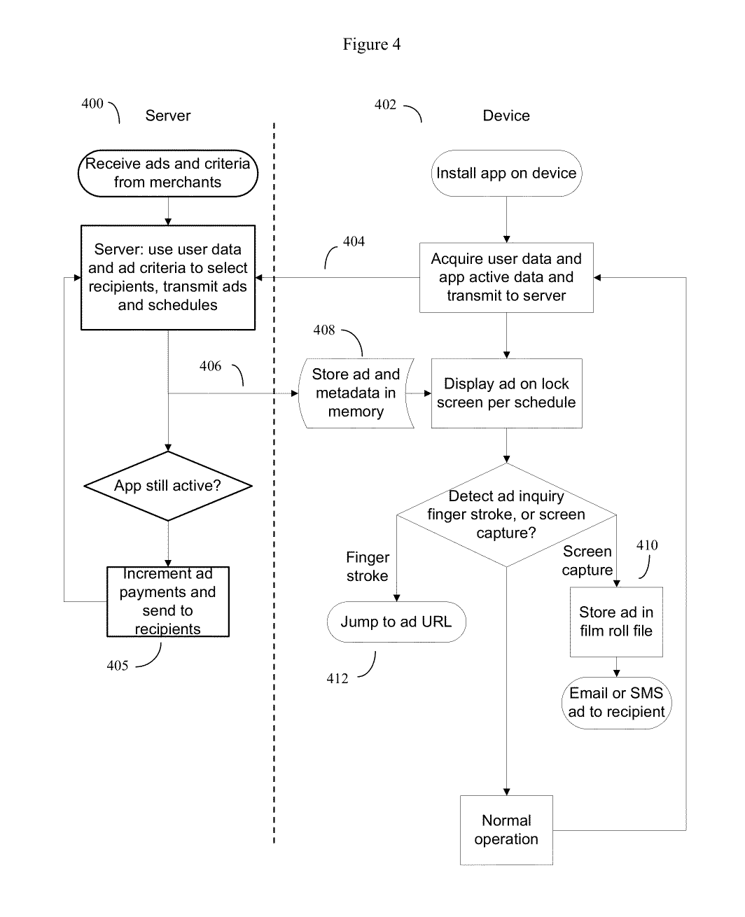

FIG. 4 shows a software flow chart showing some of the key steps on both the server and the client software that may be used to implement the present invention. The server software section on the left (400) shows some of the various software operations that are generally intended to run on the server (200) and server database (202), while the device software section on the right (402) shows the various software applications that are generally intended to run on the handheld computerized devices such as smartphones (208, 210, 212, and 214). The diagram also shows some areas where the invention's server software located on server (200) and the advertising display software app located on the various devices (208, 210, 212, and 214) exchange information over the network (204) (e.g. internet).

As one example, the software app (402) running on any of the devices (208, 210, 212, and 214) may periodically check to be sure that the app is still active (i.e. that the user has not removed or inactivated the app), and assuming that the app is still active may, along with the user data, also transmit that app active status information (404) to the server software (400) running on the server (200). The server software may in turn record this fact. Depending on how the device user rewards system is set up, the server software may, for example credit the user's account a certain amount of money (e.g. 1-10 cents a day) for every day that the app is active. The server can, as scheduled, further periodically transfer money to the device user's account, either directly (e.g. electronic transfer), or through one or more intermediate financial services (e.g. PayPal). This is shown as (405)

The server (200) and server software (400) will also, as previously described, take ad graphics file and other metadata (e.g. URL's associated with the ad, ad display schedule information, and the like) and transmit it to the various handheld devices (406), (208, 210, 212, 214) where this information will usually be stored in a memory buffer (408) onboard the handheld device.

When a user sees an ad of interest on the device lockscreen, the user can then use various methods to flag this ad for future use, or for referral to others. One of the simplest ways to capture a lockscreen ad of interest is to use the handheld device's own built-in screen capture software to capture the ad image. Here, using the Apple iPhone 4 with iOS software version 5.1 as a particular example, the operating system software is set up so that when the user simultaneously presses the “on/off” button and the “home” button, iPhone 4's operating system's built-in screen capture software captures an image of even an unactivated lockscreen, and automatically places the lockscreen image in the iPhone devices photo's camera roll file (410).

From this camera roll file, or the equivalent data file or database in other operating systems, the user may then use standard operating system functions, such as image storage and retrieval, or standard email or SMS operating software, to send image by email or SMS functions to those recipients as determined by the user.

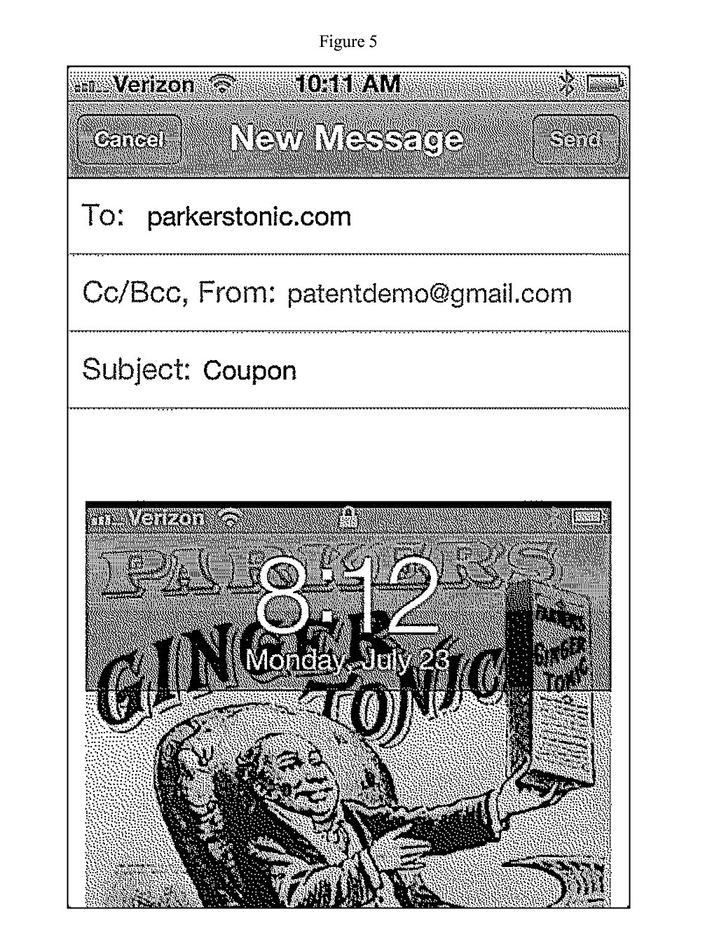

FIG. 5 shows an example of how an iPhone device user may capture a screenshot of a lockscreen ad of interest, and forward this ad (here the ad is also being used as a coupon), using the iPhone's standard operating system email software or SMS software (text messaging), to an appropriate recipient.

Alternative methods of handling an ad of interest are also possible. In an alternative embodiment, shown in FIG. 4 (412), the advertising media data transmitted by the various merchants or advertisers (206) can, in addition to one or more advertising images and advertising display schedule information, also contain at least one web universal resource locator (URL) address.

In order to use these URL addresses, the handheld device software may be further configured so that, for example, movement of a secondary lockscreen touch sensitive area, such as movement on a camera icon FIG. 1 (104) or equivalent, may cause the device software to use the system's web browser, or other internet browser or app, to jump to the URL address associated with the ad. Thus the user can go directly from a lockscreen image of an ad of interest to a web browser showing the ad's webpage.

Put alternatively, in this embodiment, advertising media can further comprise at least one web URL address, and the device advertising software app can be configured to further presents a button or active link on the lockscreen. This button or active link on the lockscreen can be further configured with the ad URL address, so that when a user presses or swipes on this lockscreen button or active link, the device opens up a web browser or equivalent corresponding to this ad URL, which will typically be an ad associated web address.

1. A method of displaying advertising media on the lockscreens of a plurality of wireless network connected handheld computerized devices, said method comprising:
installing advertising display software app on at least one of said devices, said advertising display software app configured to receive user data pertaining to said user of said device, said advertising display software app further configured to wirelessly transmit at least some of said user data to a network server, wirelessly receive advertising data from said network server, and display said advertising media on said lockscreen according to an advertising display schedule;
uploading advertising media to said network server, along with a description of a target recipient population;
using said user data, and said description of a target recipient population, to determine which of said devices should receive said advertising media, and using said network server to upload said advertising media to said at least one device;
and using said software app to display said advertising media on said lockscreen according to said advertising display schedule.

2. The method of claim 1, wherein said software app further reports its activation status to said network server, and said network server transmits rewards to the users of said devices according to at least said activation status.

3. The method of claim 2, wherein said rewards comprise electronic transmission of money either directly from said network server to said users of said devices or through one or more intermediate financial services to said users of said devices.

4. The method of claim 1, wherein said device further comprises device operating system software with a screen capture function, further using said screen capture function to capture advertising media displayed on said lockscreen and store said advertising media in a database or file in said device for future use.

5. The method of claim 4, wherein said device further comprises device operating system software with an email or text function, further using a record of said advertising media stored in said database or file to transmit said advertising media to another recipient using said email or text function.

6. The method of claim 1, wherein said network server comprises front end software, further using said front end software to upload advertising media and a description of a target recipient population from a merchant computerized device.

7. The method of claim 6, wherein said network server further comprises database software, further using said database software to match said description of a target recipient population with said user data, thereby determining which of said devices should receive said advertising media.

8. The method of claim 1, wherein said network server further comprises scheduling software, further using said scheduling software to determine a time schedule by which at least one advertising media will be displayed on said lockscreen of said device, and further transmitting said time schedule to said advertising display software app on said device to use as said advertising display schedule.

9. The method of claim 1, wherein said computerized device comprises a handheld Smartphone or a tablet computer with at least one processor, touch sensitive display screen, memory, and a wireless connection to a WiFi network and/or a Cellular network.

10. The method of claim 1, wherein said advertising media comprises advertising images, advertising images showing coupons, or advertising images showing at least one optical bar code or advertising alphanumeric serial number or phrase.

11. The method of claim 1, wherein said advertising media further comprises at least one web URL address, and wherein said software app further presents a button or active link on said lockscreen;
said button or active link on said lockscreen further configured with said at least one web URL address, and wherein said software app is further capable of detecting a user press or swipe on said button or active link on said lockscreen;
wherein after detecting said user press or swipe on said button or active link on said lockscreen, said software app, either before or after said device is unlocked, further activates a web browser interface on said device that is directed towards said at least one web URL address.

12. A method of displaying advertising media on the lockscreens of a plurality of wireless network connected handheld computerized devices, said method comprising:
installing advertising display software app on at least one of said devices, said advertising display software app configured to receive user data pertaining to said user of said device, said advertising display software app further configured to wirelessly transmit at least some of said user data to a network server, wirelessly receive advertising data from said network server, and display said advertising media on said lockscreen according to an advertising display schedule;
uploading advertising media to said network server, along with a description of a target recipient population;
using said user data, and said description of a target recipient population, to determine which of said devices should receive said advertising media, and using said network server to upload said advertising media to said at least one device;
and using said software app to display said advertising media on said lockscreen according to said advertising display schedule;
wherein said software app further reports its activation status to said network server, and said network server transmits rewards to the users of said devices according to at least said activation status; and
wherein said rewards comprise electronic transmission of money either directly from said network server to said users of said devices or through one or more intermediate financial services to said users of said devices.

13. The method of claim 11, wherein said device further comprises device operating system software with a screen capture function, further using said screen capture function to capture advertising media displayed on said lockscreen and store said advertising media in a database or file in said device for future use;
wherein said device further comprises device operating system software with an email or text function, further using a record of said advertising media stored in said database or file to transmit said advertising media to another recipient using said email or text function.

14. The method of claim 12, wherein said network server comprises front end software, further using said front end software to upload advertising media and a description of a target recipient population from a merchant computerized device;
wherein said network server further comprises database software, further using said database software to match said description of a target recipient population with said user data, thereby determining which of said devices should receive said advertising media;
wherein said network server further comprises scheduling software, further using said scheduling software to determine a time schedule by which at least one advertising media will be displayed on said lockscreen of said device, and further transmitting said time schedule to said advertising display software app on said device to use as said advertising display schedule.

15. The method of claim 12, wherein said computerized device comprises a handheld Smartphone or a tablet computer with at least one processor, touch sensitive display screen, memory, and a wireless connection to a WiFi network and/or a Cellular network.

16. The method of claim 12, wherein said advertising media comprises advertising images, advertising images showing coupons, or advertising images showing at least one optical bar code or advertising alphanumeric serial number or phrase.

17. The method of claim 12, wherein said advertising media further comprises at least one web URL address, and wherein said software app further presents a button or active link on said lockscreen;
said button or active link on said lockscreen further configured with said at least one web URL address, and wherein said software app is further capable of detecting a user press or swipe on said button or active link on said lockscreen;
wherein after detecting said user press or swipe on said button or active link on said lockscreen, said software app, either before or after said device is unlocked, further activates a web browser interface on said device that is directed towards said at least one web URL address.

18. A method of displaying advertising media on the lockscreens of a plurality of wireless network connected handheld computerized devices, said method comprising:
installing advertising display software app on at least one of said devices, said advertising display software app configured to receive user data pertaining to said user of said device, said advertising display software app further configured to wirelessly transmit at least some of said user data to a network server, wirelessly receive advertising data from said network server, and display said advertising media on said lockscreen according to an advertising display schedule;
uploading advertising media to said network server, along with a description of a target recipient population;
using said user data, and said description of a target recipient population, to determine which of said devices should receive said advertising media, and using said network server to upload said advertising media to said at least one device;
and using said software app to display said advertising media on said lockscreen according to said advertising display schedule;
wherein said advertising media further comprises at least one web URL address, and wherein said software app further presents a button or active link on said lockscreen;
said button or active link on said lockscreen further configured with said at least one web URL address, and wherein said software app is further capable of detecting a user press or swipe on said button or active link on said lockscreen;
wherein after detecting said user press or swipe on said button or active link on said lockscreen, said software app, either before or after said device is unlocked, further activates a web browser interface on said device that is directed towards said at least one web URL address;
wherein said software app further reports its activation status to said network server, and said network server transmits rewards to the users of said devices according to at least said activation status; and
wherein said rewards comprise electronic transmission of money either directly from said network server to said users of said devices or through one or more intermediate financial services to said users of said devices;
wherein said network server comprises front end software, further using said front end software to upload advertising media and a description of a target recipient population from a merchant computerized device;
wherein said network server further comprises database software, further using said database software to match said description of a target recipient population with said user data, thereby determining which of said devices should receive said advertising media;
wherein said network server further comprises scheduling software, further using said scheduling software to determine a time schedule by which at least one advertising media will be displayed on said lockscreen of said device, and further transmitting said time schedule to said advertising display software app on said device to use as said advertising display schedule; and
wherein said computerized device comprises a handheld Smartphone or a tablet computer with at least one processor, touch sensitive display screen, memory, and a wireless connection to a WiFi network and/or a Cellular network.

19. The method of claim 18, wherein said device further comprises device operating system software with a screen capture function, further using said screen capture function to capture advertising media displayed on said lockscreen and store said advertising media in a database or file in said device for future use;
wherein said device further comprises device operating system software with an email or text function, further using a record of said advertising media stored in said database or file to transmit said advertising media to another recipient using said email or text function.

20. The method of claim 18, wherein said advertising media comprises advertising images, advertising images showing coupons, or advertising images showing at least one optical bar code or advertising alphanumeric serial number or phrase.
